(19) United States
(12) Patent Application Publication
(10) Pub. No.: US 2005/0065876 A1
(43) Pub. Date: Mar. 24, 2005

(54) Airbank, pay to anyone from the mobile phone

(76) Inventor: Pulkit Kumar, Chandigarh (IN)

Correspondence Address: PULKIT KUMAR, 5139 GROUND FLOOR, MODERN HOUSING COMPLEX, MANI MAJRA, CHANDIGARH, 160101, IN

(21) Appl. No.: 10/435,580

(22) Filed: May 12, 2003

(51) Int. Cl. G06F 17/60

(52) U.S. Cl. 705/39; 705/43

(57) ABSTRACT

A method and a system are provided for making transactions from a mobile phone by creating an intermediate transaction account.

### BACKGROUND OF THE INVENTION

The present invention enables a user to pay any type of bill through the mobile station (like cellular phone). From the recent decades, the system of paying through cash has been discouraged due to risk involved in carrying cash i.e. of theft, burglary etc. Also the other associated problems including carrying of cash, shortage of less value coins, preserving the currency notes, add into the disadvantages of cash payment. So the credit cards were introduced. But these cards too are quite unsafe because the fact that anybody may copy the card details and use it at many places including internet. So in the age of modem electronics, some electronic device that is already in the hands on billions of people should be used. This device should be very secure, and easy.

One existing effort in which the process of payments from the mobile phone a/c to other mobile phone a/c, is described in U.S. Pat. No. 5,991,749.

In this invention, the inventors have described a process of direct funds transfer between cell phone accounts, that can enable face to face transactions but the system does not implements “simultaneous give and take” method described hereinafter.

Also in U.S. Pat. No. 6,516,996 a system of generating electronic receipts is described.

### BRIEF SUMMARY OF THE INVENTION

The present invention is aimed at making payments from a mobile phone's account to other mobile phone's account, bank account, ATM cash. It allows user to make a transaction in some official cases like in a (not limiting) magazine subscription form, visa application form, school fees form, examination form, court fees etc. In simple and brief language, it enables a person to let the recipient withdraw from an a/c similar to bank a/c having the required money. In other words, it is similar as to creating a joint a/c with the recipient and deposit the money to be sent, in that a/c. The recipient may withdraw the money from the a/c according to his own needs. The user (sender) may obtain a receipt for the money in new a/c, from the beneficiary. The present method of invention makes the system of payments highly secure and easy. It avoids the risk involved with credit/debit cards also it ensures the full record of the debtor, creditor & transaction. Also it makes possible for a person to withdraw the cash from ATM (automatic teller machine) but debit the funds from the account of mobile phone.

### BRIEF DESCRIPTION OF DRAWINGS

For a fuller and easy understanding of the invention, reference should be had to the following detailed description taken in conjunction with the accompanying drawings in which:

FIG. 1 is a general structure of ‘menu’ to be created for the ease of user;

FIG. 2 is a basic structure of links between airbank and other networks.

### DETAILED DESCRIPTION OF THE INVENTION

Basic Requirements and Modifications

The cell phone usually has an account which keeps record of bills issued against the calls made. Funds may be debited or credited by the server maintaining the said a/c upon request initiated by cell phone user. For the present invention ‘airbank’ the cellular network a/c should have permission to debit funds from the user's cell phone a/c upon a request initiated by an authorized user of that cell phone. Also certain modifications and interconnections have to be performed in wireless mobile station (mobile phone)'s account, SIM cards (subscriber's identification module), bank and ATM connectivity; as described hereunder.

Modifications in SIM (Subscriber's Identity Module) Card

A SIM for a mobile station used in a GSM mobile communication system being adapted to add some extra features and functions to the mobile station. The application gets stored on the SIM card but apparently appears to the user that the application is set-up on the mobile station. This system is being used very commonly by many companies and they are providing some extra features like astrology, news, jokes, downloads etc. The 32 k based SIM cards are best suited chips for the purpose mentioned herein under till present date. These have added feature of having a WAP (wireless applications protocol) browser that an old handset may or may not contain.

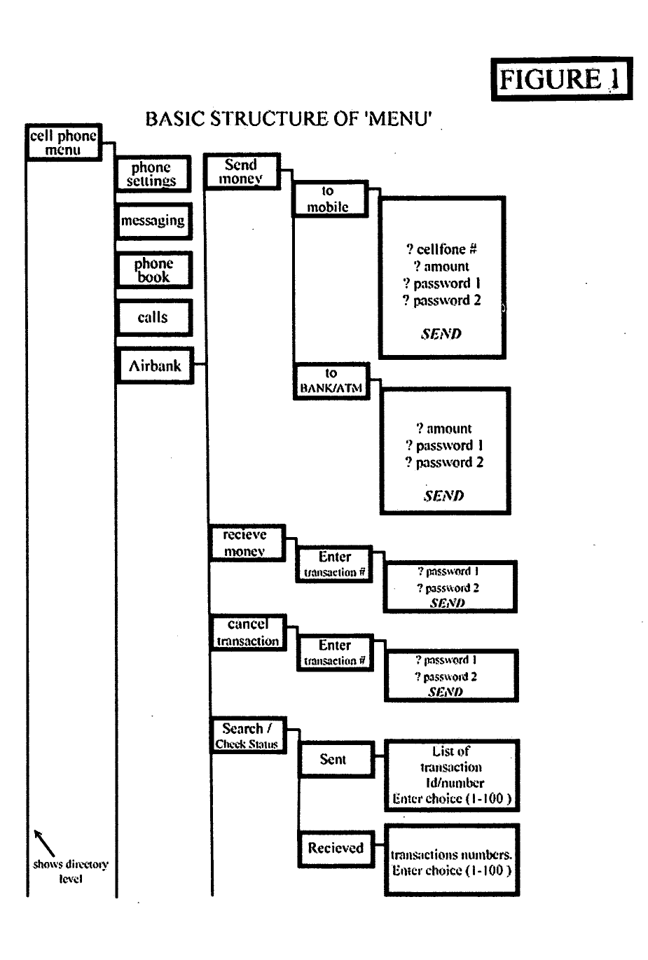

Also for the present invention (hereafter to be referred as airbank), a separate menu is setup/created by the service provider on the SIM card. The menu is described in FIG. 1. For the mobile stations, in which WAP service is available, the same menu may be WAP based in which simultaneous exchange of information takes place.

For mobile stations, where WAP service is unavailable but SMS (short message service) is available, the same menu may be formed using SMS as a medium for communication. In the working of the menu without WAP, the mobile station automatically sends an SMS (the system automatically writes in the required format which is decoded at the service provider's server) for any request made by user to send or receive data. The user will not have to manually set the parameters and formats of the SMS, the mobile station will automatically send the SMS.

For the existing customers with old SIM cards (not containing the menu), the SIM card may be changed with an agreement between the service provider and customer.

They may also communicate with service provider's server by sending an SMS in the format in which the above said SMS based menu driven does.

They may also communicate with the server through preprogrammed voice system. But the only lagging or disadvantage with this system is that the text can only be numerals. Alphanumeric symbols cannot be used.

The server notifies the user by sending the message in FLASH SMS format. FLASH SMS prevents a user with ordinary skill in the art, to modify the message.

Benefits of Interconnectivity

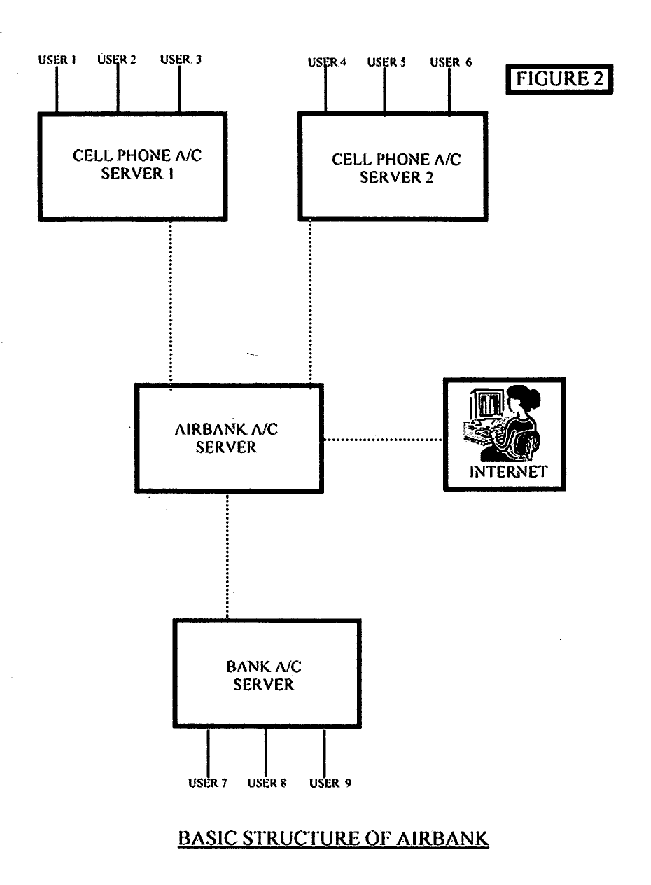

The efficiency of use of the present invention ‘airbank’ directly depends upon the interconnectivity between the different networks of cellular mobile phone with the airbank server and the connectivity of banks with airbank server as shown in FIG. 2. But if an agreement between the cellular operators may not be established, the airbank may still be established in a single network. But only a single network would make its scope local in that network only. User may not accomplish to send money to a mobile station working under different network. But this invention a large scale business with huge profits for all cellular operators and banks. So interconnectivity should get established easily.

For the system to operate there should a central bank a/c (hereafter to be called “airbank a/c server”) that may be operated by the registered cellular network operator a/c servers and the connected banks. The airbank a/c server is fully connected to registered cellular network a/c servers and banks. This implies that the cellular a/c servers may request for creating a temporary account (now to be hereby known as transaction) and transferring funds for the same and even withdrawing funds from a transaction. The banks may also withdraw funds from a transaction.

Also the currency will have to be uniform. Or the system of points may also be established. The whole system is almost like connecting a computer to the internet and bankers tying up with credit card companies. The hardware involved in the interconnection of banks and cellular phone servers with airbank should be independent and should not depend upon local factors like internet service of nearby local ISP. They should have direct high speed and highly secure connectivity with airbank. Services like Direct Satellite Link (DSL) may be used.

Modifications in ATM Machines

The ATMs enabled to retrieve cash from cell phones must have a separate menu for airbank, having menu options for filling in transaction number, and two passwords using the alpha numeric keypad of ATM previously used for entering PIN.

Method of Making Payments from Cellular Mobile Phone (Cell Phone)

This may be accomplished in either two ways. Firstly payments may accomplish cell phone to cell phone, Secondly from cell phone to bank a/c or cash.

Method of Making Payments from Cell Phone to Cell Phone

The method of this present invention makes it possible to use the wireless mobile station which will be hereafter referred to as cell phone, as billing device for making transaction from one cell phone to other and/or cell phone to bank a/c and/or cell phone to cash.

The airbank structure uses above described separate airbank menu stored on SIM and/or pre described SMS (short messaging service) and/or automatic voice enabled interactive menu (data is transmitted by pressing keys from keypad which further get converted into DTMF—dual tone multi frequency signals) for communication between the cell phone and the service provider's processing unit.

For sending funds from one cell phone to another, the following data is required for the sender (now to be known as creditor).
1) The exact cell phone number of the receiver (now to be known as debtor) along with full area and country codes.
2) The exact amount of funds to be transferred.
3) The two passwords (may be arbitrary, may be any). The passwords have to be of 5-8 characters.
4) A connected cell phone.
5) Minimum equivalent (if different currencies are used) amount of money in the cell phone a/c as required for transaction if the a/c type is debit or prepaid. If the postpaid or credit type a/c is used, enough credit limit at least equivalent to transaction money must be available.

For the user, the first step in the process is to open the airbank menu.

Now as the airbank menu is opened, the menu prompts for the PIN of the cell phone. The PIN is always stored on the SIM card for user identification and allowing only authorized access. In the second step, upon successful submission of PIN, the creditor enters the above mentioned necessary data on the cell phone menu as shown above under ‘menu’. This information is then sent to the service provider of the creditor's cell phone. Upon successful sending, the service provider's server prompts for reentering the two passwords for verification of passwords by the creditor.

When the both passwords are successfully reentered and sent, the information is recorded on the service provider's server. The server automatically debits the requested amount of funds to be transferred from the creditor's cell phone account and assigns the information (now to be referred to as ‘transaction Data’) a temporary identification number which will be in the format
‘Datetime’

E.g. if the transaction data is sent 20th Oct. 1984 at 11:11, then the temporary identification number will be 2010841111.

As soon as the server assigns a temporary identification number, the server transmits the transaction data to the airbank a/c server. The server then checks for the validity of the debtor's cell phone number and that it is connected and its service provider is connected to the airbank a/c server.

If the debtor's cell phone number is invalid (this may be due to incorrect format of debtor's cell phone number) and/or his/her service provider is not connected or/and registered to airbank a/c server, the airbank rejects the transaction and the airbank automatically sends rejection intimation to the creditor's cell phone by SMS or by automatic preprogrammed voice intimation. The creditor's service provider automatically credits the amount which it had debited for making the transaction. Also if intimation fails, the creditor may check for the status of his transaction by entering the unique temporary transaction identification number in the airbank menu as shown in FIG. 1.

If all the particulars of transaction data are correct, the airbank a/c server creates an a/c similar to a bank a/c which is temporary in nature. i.e. the said a/c deletes itself at the moment when either the creditor or debtor withdraw the funds from the a/c. but the server records the transaction data permanently in its record so that anytime query/legal inquiry may be done regarding that a/c. This airbank a/c is almost similar to that to a joint bank a/c, the difference between airbank a/c and simple bank a/c lies in the fact that with the airbank a/c, the debtor can only debit the funds from a/c. And that the credits to the a/c can only be transferred at the time of creation and the whole amount of money has to be debited at once, thus the deletion of a/c takes place automatically with the withdrawal. The debtor may be easily identified with the cell phone number and verified by the passwords. The server will issue an a/c number (now to be known as transaction number) to this new a/c and store all the transaction data in its memory. The airbank a/c server immediately informs the creditor and debtor the transaction number, the amount of transaction, date, time, sender's cell phone number, and receiver's cell phone number.

The creditor now has the transaction number and he/she may always check for status of transaction. The debtor now has information that there is an incomplete transaction for his cell phone number. The two passwords have to be manually disclosed by the creditor to debtor through his own means. The debtor may anytime transfer the funds to his cell phone provided the creditor has disclosed debtor the passwords. For implementing simultaneous give and take system, the creditor may disclose one password to the debtor and ask him to prepare a receipt and start delivery of the service/goods against for which the transaction is to. And then disclose the second password and get the final receipt.

For transferring/retrieving the transaction money into the cell phone account of debtor, the debtor opens the receive money menu option in above described menu. The debtor fills the transaction number, and the first password and the second password (if disclosed by the creditor). The data is sent is sent to the debtor's server. The debtor's server automatically sends the data along with debtor's cell phone number to airbank a/c server for verification. Upon verification of the debtor's cell phone number and first password, the airbank main a/c server prompts the debtor's cell phone service provider's server for the second password. The server sends second password (if disclosed by the creditor) and if again the second password verifies, the said money is transferred from airbank a/c server to debtor's service provider's server and the said airbank a/c is instantly deleted, recording the transaction details in permanent records. An immediate intimation is sent to the creditor informing him the transaction is complete along with transaction number, amount of transaction, date time of placing and retrieving the transaction and cell phone number to which the said funds have been transferred. The transaction finds received by the debtor's server are credited to the debtor's cell phone number. If second password is incorrect the airbank a/c server discards the request and transmits a message to the debtor informing that the second password does not match. The debtor will now have to repeat the process.

This helps the creditor to avoid all haphazard of denial of the debtor to receive the funds.

Even if cell phone-is not available to the debtor at the time of deal, the debtor may check for the verification of passwords on the internet.

The creditor may obtain the receipt against the transaction money received by the debtor in the suitable format.

Also if after making a transaction by the creditor, the transaction has to be cleared by the creditor due to some reasons; the creditor always has an option to delete the transaction by entering to the specific cancellation menu under airbank menu as described above.

For enhanced safety, the creditor has to enter the transaction number and the two passwords under the menu option “cancel transaction” for cancellation of transaction. The debtor will be immediately intimated of the cancellation of transaction under his cell phone number.

Making Payments from Cell Phone to Bank Account or Cash

For paying from the cell phone to any non cell phone based receiver, like bank a/c etc, the present invention may be used. The process described in this subset of the present invention may be used to make payments from cell phone to some official fee fillings such as admission forms, government forms, visa applications, school forms, court fee forms, examination forms and magazine subscription forms etc wherein the process cited in above context for payments from cell phone to cell phone will not be easy and practical. In some cases (as cited here above) it may not be not possible to request somebody to receive payments on his/her cell phone. Like in case of credit cards, it is always asked in application forms etc to mention the credit card details and payments will be made against your card by the regarding officials of that application.

In such cases simultaneous process of give and take does not take place. These processes use some official types of payment systems involving least electronic devices and maximum work that can be presented on the paper. In the above cited examples, the debtor must have a freedom to retrieve the money at the time he/she wants.

Using the below cited description, the cell phone may be easily used for making such types of payments.

The requirements for making a cell phone to non cell phone based payments are:
1) The amount of transaction.
2) The two passwords(between 5-8 characters)
3) Enough money (at least equivalent to the transaction amount) in a/c if debit type card is used and enough credit limit in a/c if credit type a/c is used.

The creditor goes to airbank menu and fills the PIN (personal identification number) and opens the “make payment” and then “non mobile” submenu. The creditor enters the transaction data into the menu as prompted and then sends the transaction data to the creditor's cell phone network a/c server and the server checks for the money available/credit availability for debit/credit type accounts respectively which when on being successful with debiting/crediting, creates a temporary id as made in cell phone to cell phone type payments. The network server automatically transmits the temporary id to the creditor and sends the transaction data to airbank a/c server. The airbank a/c server creates an a/c similar to a bank a/c which is temporary in nature. i.e. the said a/c deletes itself at the moment when either the creditor or debtor withdraw the funds from the a/c, but the server records the transaction data permanently in its record so that anytime query/legal inquiry may be done regarding that a/c. This airbank a/c is almost similar to that to a joint bank a/c, the difference between airbank a/c and simple bank a/c lies in the fact that with the airbank a/c, the debtor may only debit the funds from a/c, and that the credits to the a/c may only be transferred at the time of creation and the whole amount of money has to be debited at once, thus the deletion of a/c takes place automatically with the withdrawal. The debtor may be easily identified with the name provided by bank and verified by the passwords. The airbank a/c server issues a number to the a/c (hereafter to be known as transaction number) and asks the creditor's a/c server to send the transaction money. The airbank a/c server on receiving the money from the creditor's a/c server transfers the said money into that transaction number and intimates the creditor for the transaction number, transaction value in currency in which the transaction is made, date and time of the transaction.

The debtor may retrieve his money in two possible ways.
1) from a bank
2) from ATM
1) From a bank—the bank described therein above requires the transaction number, the two passwords and a debtor's personal bank a/c with the bank. The bank connects itself to the airbank a/c server and sends the debtor's account name, account number, the full bank details, transaction number, and the two passwords. Upon successful matching of passwords for the given transaction number, the airbank sends the transaction money to the bank. The bank then transfers the money into the debtor's bank a/c only. The airbank immediately intimates the creditor with the transaction number, debtor's name, transaction amount, date time of making transaction and date time of retrieving the money.
2) From an ATM—the ATM described above may also retrieve the money from Airbank and deliver instant cash in hand of the debtor. The debtor requires the Transaction number, the two passwords and a bank ATM card or debit/credit Card. The debtor will have to insert the card and open special airbank menu on the ATM computer screen. Using the ATM keypad, the debtor requires filling in all the particulars of the transaction—Transaction number, the two passwords into the airbank menu as prompted. The ATM machine automatically connects its computer to the bank server and gives the following information to the bank server:
   Name of debtor
   Card type of the debtor along with card number of the debtor.
   Transaction number
   The two passwords
      the bank server connects to the airbank a/c server and gives the above information sent by the ATM. The airbank stores the sent information and verifies the two passwords for the given transaction number. If the passwords match, the airbank sends the transaction money to the bank server. The airbank sends the ac knowledgement intimation to the creditor with the transaction number, transaction value, and name of the debtor, date and time of retrieval of money and date and time of making a transaction. The ATM when again checks for the clearance of the transaction, the bank server informs the ATM that the requested transaction has been successful and permits the delivery of cash against the requested ATM/debit/credit card number. The debtor thus collects the cash. The ATM gives a printed receipt for the whole transaction.

This system may also be opted for transferring the funds from cell phone a/c to cash instantly where in the creditor creates a new transaction described hereinabove with debtor being same as creditor.

Process of Payment from Cell Phone on Internet.

For paying from a cell phone to the other person/company etc on the internet, the above two (payments to cell phone; bank, ATM) systems may be used. The first one has full security for the debtor but the latter one has a little bit insecurity as the creditor may not sign the transaction data. Since the user may always change or delete the transaction in the latter case, if suppose here is a situation of gaining access over a website and the second payment option is chosen for the purpose. And the transaction is made by the creditor. But it may not be easy to go to the bank or ATM to verify the transaction and involved passwords. So for this purpose, debtor may log on to the internet and go to the website of airbank and check for the status and details of the transaction by entering the transaction number and the two associated passwords. The debtor may even lock the transaction so that the creditor cannot change the passwords nor the creditor may delete the transaction.

### EXAMPLES IN SUPPORT OF THE PRESENT INVENTION

### Example 1

This example describes the implementation of the cell phone financial transaction for the cash-equivalent purchase of good(s) or service(s). For such transactions the cell phone functions as a credit/debit card. In this example, the cell phone is used to complete the transactions for the good(s) purchased from a shop keeper. The funds are to be credited to his cell phone a/c.

The user goes to airbank menu as shown in FIG. 1 attached herewith. The user enters all the data (shopkeeper's cell phone number, amount and the two passwords) and sends the transaction data to the service provider's special access number. The service provider's server then debits the sum from the user's a/c and sends the transaction data to airbank a/c server. The server checks for the shopkeeper's cell phone number and if successful, and gets money from the service provider's server, creates a temporary a/c attaching the transaction data with the a/c.

The user and the shopkeeper are instantly notified for the transaction number. The shopkeeper then asks for the passwords and the user gives him first password which when shopkeeper verifies, the user asks the shopkeeper for receipt and that to start delivery. After the user is satisfied with the shopkeeper, the user provides him the second password. The shopkeeper again sends the transaction data for retrieving the funds, when all the transaction data is verified, the airbank a/c server sends the transaction money to service provider's server and the service provider automatically credits the sum into shopkeeper's account.

### Example 2

This example describes the implementation of the cell phone financial transaction for the cash-equivalent fee of good(s) or service(s) from the magazine subscription office. For such transactions the cell phone functions as a credit/debit card. In this example, the cell phone is used to pay the magazine subscription fees by mentioning the payment options and details on the magazine subscription form. Like when paying from credit card, it's always asked to mention the credit card details, the same way airbank may be used to pay the fees. The user enters all the data (amount and the two passwords) and sends the transaction data to the service provider's special access number. The service provider's server then debits the sum from the user's a/c and sends the transaction data to airbank a/c server. The server gets money from the service provider's server, creates a temporary a/c attaching the transaction data with the a/c.

The user is instantly notified for the transaction number. The user writes the transaction number and the two passwords onto the form, and sends it to the magazine company. The magazine company sends an official representative to the bank in which the magazine holds an account. The representative fills a from in which he/she mentions the bank account number of the magazine, the transaction number, and the two passwords and submits for clearance. The bank officials connect to airbank a/c server and submit all the data including the account name into which the transaction is being transferred to. The airbank when verifies all the data, clears the transaction and sends the money to the bank and bank credits into magazine's a/c and give a receipt for credit. The user is immediately informed by the airbank about the completion of transaction and gives the debtor's account name, amount debited date time. If magazine officials try doing a fraud, and debit the funds into some account and deny to the user that the transaction was invalid, the user may check for the bank details and account to which the said funds are debited. And any regarding legal action may be sought.

### Example 3

This example describes paying to a recipient online via internet from the cell phone. The user may make a cell phone payable transaction as described in example 1 or if the receiver does not want payment on to his cell phone, the user may proceed as in example 2. But if the service the recipient is providing like access to a website, either user will have to wait for the time recipient takes to clear the transaction, or the recipient may take a risk. The other process that may be performed is that the recipient may log on to airbank's website and enter all the transaction details and if verified, the recipient may lock it and now the user cannot delete the transaction. And immediately the recipient starts the service. After some time, the recipient may go to bank and debit the money from transaction.

### Example 4

This example describes the implementation of the cell phone to withdraw cash from ATM machine but debit the funds from the cell phone a/c. This means if user doesn't have enough money in his/her bank a/c, he may use the cell phone a/c as money source. For the process, the user makes a non-cell phone based payment, and as described in example 2, user receives the transaction number. The user inserts his/her ATM/DEBIT/CREDIT card into ATM machine and opens a special airbank menu on the ATM machine and enters all the transaction data. The ATM sends the transaction data to the bank along with the card number and card name of the user. The bank connects to airbank and requests for the funds. The airbank after verifying the transaction data sends the funds to the bank. The bank server informs the ATM or ATM checks itself after connecting again (say after 30 seconds) that allow the issuance of cash against the ATM card of the user. And the user may get the cash. Also this example may also implement getting of funds directly in form of cash instead of crediting it into bank a/c (example 2). The user will be intimated with the card details and if something fraud is in between the withdrawer may be tracked by the ATM/CREDIT/DEBIT number.

Benefits form the Present Invention

1) Security—the funds cannot be debited until the exact match of transaction number, and the two passwords take place. If the data is accidentally disclosed, the transaction still may be deleted. Also if the transaction is debited, the exact name and details of the debtor may be investigated.

2) Ease of use—the user friendly airbank menu as described in FIG. 1 makes the practical usage of airbank very easy. Also the data transfer takes place at a very high speed which ensures speedy transaction.

3) It deletes all the haphazard of direct cell phone to cell phone data transfer. In these types of data transfers, the data might get blocked in between. But in airbank, since user creates a database for the recipient somewhere else, there is no problem in receiving the data on the recipient cell phone.

4) This invention clearly implements simultaneous give and take system as well as face to face communication.

5) The main advantage with this present invention is that even if an unauthorized person withdraws the money from the airbank via bank/ATM type money transfer, the culprit can only withdraw the separated funds. But in case of credit card having a large credit limit, the culprit may empty the whole account.

6) For the cell phone network companies, this invention may generate a lot of revenue. As the airbank service shall be popular, more users will use this service and they may avail high profits by providing less interest rate on cell phone account as compared to other sources. The prepaid users may prefer transferring more funds to their accounts, thereby increasing the capital availability to the cell phone companies. Also the postpaid users will have to pay all the bills at the end of a fixed period of time, and the cell phone companies may avail high interest rates on the bills for this period of time.

7) As many cell phone companies may work together, this may result to better cooperation between the companies.

8) It may promote distant payments like ordering food from hotel through cell phone.

9) It may promote variety of other added services on cell phone like buying of ring tones, accessories etc.

Further Expansion

Further, the above described invention may also accompany banks to create transaction accounts, to benefit people not possessing a cell phone.

1) A method of transferring funds electronically between two cellular phone accounts (a/c) by creating an account at a central a/c server, transferring the required funds into the a/c, retrieval of said funds from that a/c by the recipient; the method further comprising of a process of creating an account at the central a/c server; the process further comprises of entering the transaction data comprising recipient's cellular phone number, amount, two passwords under “create transaction” menu option; sending of the data to sender's cellular network a/c server; debiting the said funds from the sender's cell phone a/c simultaneously providing the sender a temporary ID for the debited funds by the sender's cell phone service provider, sending the money alongwith transaction data with further including sender's number, date/time of sending, to central a/c server; verifying the transaction data by the central a/c server, creating a transaction a/c upon successful verification, storing the transaction data with the a/c, assigning an a/c number to the transaction a/c, notifying the sender, the recipient, the transaction a/c number, amount, sender's and recipient's cell phone number;
Entering the account number, the two passwords under “get money” menu option by the recipient, sending the data to the recipient's cellular network server, sending of this data along with recipient's cell phone number by the recipient's cellular network server to central account server, verifying the data by the central a/c server, sending the money to recipient's cell phone network a/c server simultaneously deletion of account upon successful verification simultaneously notifying the sender by sending the recipient's cell phone number, amount, account number, transferring of funds into the cell phone account of recipient by the cell phone network a/c server.

2) The method recited in claim 1 wherein the said menu is extra menu driven automatic SMS.

3) The method recited in claim 1 wherein the said transaction Id is automatically generated by the sender's cellular network a/c server in a general format of ‘DATETIME’ (date, time) of sending the transaction data by the sender.

4) The method recited in claim 1 wherein the said funds are credited into the transaction a/c only at the time of creation of a/c; all funds are to be debited when at the time of withdrawal; the said transaction a/c deletes itself upon successful withdrawal of funds, storing all the records of transaction in a separate memory in central a/c server.

5) The method recited in claim 1 wherein the said method of verification of transaction data sent by the recipient's cellular network comprises of first step of verification of recipient's cell phone number; second step of verification includes verifying the first password for the given transaction number, the server proceeds to step 3 with successful password match at step 2 else quits, notifying the recipient the passwords mismatch; third step of verification includes verifying the second password for the given transaction number, the server proceeds to debit the funds upon successful password match at step 3 else quits notifying the recipient, mismatch of second password.

6) The method recited in claim 1 wherein the said notifications by the server to user comprises transmitting FLASH SMS by the service provider to user.

7) A method of transferring funds electronically between a cellular phone account and a bank account by creating an account at a central a/c server, transferring the required funds into the a/c, retrieval of said funds from that a/c by the recipient's bank; the method further comprising of creating an account at the central a/c server, which further comprises of entering the transaction data comprising amount, two passwords under “create transaction” menu option; sending of the data to sender's cellular network a/c server; debiting the said funds from the sender's cell phone a/c simultaneously providing the sender a temporary ID for the debited funds by the sender's cell phone service provider, sending the money alongwith transaction data with further including sender's number, date/time of sending, to central a/c server; creating a transaction a/c upon successful verification, storing the transaction data with the a/c, assigning an a/c number to the transaction a/c, notifying the sender, the transaction a/c number, amount;
Entering the transaction data comprising transaction a/c number, the two said passwords onto the bank's pay in form; transmitting the transaction data alongwith debtor's bank a/c name, bank a/c number to central a/c server by the involved bank; verifying the data by the central a/c server; Debiting the funds from the central a/c to debtor's bank simultaneously notifying the sender the transaction data alongwith debtor's a/c name, debtor's a/c number, bank's name; crediting the said funds to the debtor's account.

8) The method recited in claim 7 wherein the said bank maintains the identity of the account holder at its own risk, thus facilitating the legal authorities to make any legal enquiries about the transferred funds.

9) A method of transferring funds electronically from a cellular phone account to a bank ATM cash by creating an account at a central a/c server and transferring the required funds into the a/c, retrieval of said funds from that a/c by the ATM; the method further comprising of creating an account at the central a/c server, which further comprises of entering the transaction data comprising amount, two passwords under “create transaction” menu option; sending of the data to sender's cellular network a/c server; debiting the said funds from the sender's cell phone a/c simultaneously providing the sender a temporary ID for the debited funds by the sender's cell phone service provider, sending the money alongwith transaction data with further including sender's number, date/time of sending, to central a/c server; creating a transaction a/c upon successful verification, storing the transaction data with the a/c, assigning an a/c number to the transaction a/c, notifying the sender, the transaction a/c number, amount;
Providing the personal information by debtor to the ATM by swiping the ATM/CREDIT/DEBIT card; entering of the transaction data comprising transaction a/c number, the two said passwords into ATM machine; transmitting of transaction data alongwith the debtor's card number, name to the pertaining bank server; sending of the data further to central a/c server by bank server; verifying the data by the central a/c server; debiting the funds to the said bank a/c server simultaneously notifying the sender the transaction data alongwith debtor's name; the bank further grants permission to deliver cash to user; the said ATM instantly delivers cash alongwith issuing a delivery receipt to the debtor.

10) The method recited in claim 9 wherein the said sender, recipient can be a same entity; the method facilitating converting of funds from cell phone account to cash.

11) The method recited in claim 9 wherein the said data comprising two passwords, transaction number are entered into ATM using a preconfigured menu stored on ATM computer.
